(19) United States
(12) Patent Application Publication
(10) Pub. No.: US 2007/0165652 A1
(43) Pub. Date: Jul. 19, 2007

(54) Communication Terminal Device, Communication Method, and Communication System

(75) Inventor: Osamu KIMOTO, Kyoto-shi (JP)

Correspondence Address: HOGAN & HARTSON L.L.P., 1999 AVENUE OF THE STARS, SUITE 1400, LOS ANGELES, CA, 90067, US

(73) Assignee: MURATA KIKAI KABUSHIKI KAISHA, Kyoto-shi (JP)

(21) Appl. No.: 11/565,431

(22) Filed: Nov. 30, 2006

(30) Foreign Application Priority Data
Jan. 18, 2006 (JP) 2006-010323

(51) Int. Cl. H04L 12/56

(52) U.S. Cl. 370/401

(57) ABSTRACT

A facsimile machine, which is an analog communication terminal connected to a facsimile machine of another end via an IP network, monitors a silence generating interval by detecting energy of a signal received from the facsimile machine of the other end. When a silent state generates periodically, the facsimile machine judges that the communication is abnormal caused by a packet loss. When the communication is judged to be abnormal, the communication is interrupted or the communication speed is decelerated.

### RELATED APPLICATIONS

This application claims priority under 35 USC 119 in Japanese patent application no. 2006-010323, tiled on Jan. 18, 2006, which application is hereby incorporated by reference in its entirety.

### BACKGROUND OF THE INVENTION

1. Field of the Invention

The present invention relates to a communication terminal device such as a facsimile machine, which carries out an information communication via an Internet Protocol (IP) network. The present invention also relates to a communication method using the communication terminal device, and a communication system including the communication terminal device.

2. Description of the Related Art

A facsimile communication is carried out via an IP network, which is a communication network using an IP communication protocol. In such a facsimile communication system, a transmitter facsimile machine and a recipient facsimile machine are connected via an IP network. A transmitter gateway device, which carries out an analog-to-digital conversion, is provided between the IP network and the transmitter facsimile machine. A recipient gateway device, which carries out a digital-to-analog conversion, is provided between the IP network and the recipient facsimile machine.

After the transmitter facsimile machine accesses the IP network via the transmitter gateway device, the transmitter facsimile machine establishes a connection with the recipient facsimile machine via the recipient gateway device. Then, between the transmitter facsimile machine and the transmitter gateway device, and between the recipient gateway device and the recipient facsimile machine, a communication is carried out under an analog communication line switching method. Between the transmitter gateway device and the recipient gateway device, a communication is carried out under a digital packet switching method. As described above, by carrying out the analog-to-digital conversion by the gateway devices, an IP information communication using the IP network can be carried out between facsimile machines, which are analog communication terminals.

According to a known communication relay method using an IP network as described above, an IP packet is built with a frame as a unit, and the built IP packet is transmitted to the IP network. Under such a communication relay method, an analog signal including a prescribed frame transmitted from the transmitter facsimile machine is encoded into a digital signal. The digital signal is extracted per unit byte, and a start code and an end code of the frame are distinguished from the digital signal per extracted unit byte. Then, in accordance with the start code and the end code, an IP packet is built with the frame as one unit.

According to another known communication system, a transmitter encodes a voice and/or a facsimile signal, and distinguishes whether or not the encoded data is a silence. When the encoded data is a silence, the transmitter sets a silence flag to the encoded data, and transmits a packet to the IP network.

In a facsimile communication carried out via an IP network, a packet loss frequently generates within the IP network, and a silent state generates frequently and appears in the analog communication line between the gateway device and the facsimile machine. When such a silent state appears frequently, a Modulator-Demodulator (MODEM) of the facsimile machine cannot respond to a fluctuation in signal energy resulting from repetition of a sound state and a-silent state. As a result, communication time is increased, or the MODEM may break down.

### SUMMARY OF THE INVENTION

In order to overcome the problems described above, the present invention provides a communication terminal device, a communication method, and a communication system capable of preventing unnecessary increase in communication time and a breakdown of the MODEM or the like resulting from packet loss.

According to an aspect of the present invention, a communication terminal device includes a monitor unit, a determining unit, and a judging unit. The monitor unit monitors a silence generating interval by detecting energy of a voice receiving signal received via an IP network. The determining unit determines whether or not the silence generating interval monitored by the monitor unit is periodic. The judging unit judges that the communication is abnormal when the determining unit determines that the silence generating interval is periodic.

In case of a general analog communication line not using the IP network, such a silent state generates only incidentally. However, in case of an analog communication line using the IP network, the silent state generally generates periodically. Therefore, according to the present invention, the communication terminal device detects the energy of the voice receiving signal to monitor the silence generating interval, and determines that the communication is abnormal when the silent state generates periodically. Since a communication abnormality resulting from a packet loss can be judged, communication time is prevented from becoming unnecessarily long, and the MODEM is prevented from breaking down.

According to another aspect of the present invention, the communication terminal device includes an interrupting unit which interrupts the communication when the judging unit judges that the communication is abnormal.

When the silent state generates periodically and the communication is judged to be abnormal, the communication is interrupted. Thus, communication time is prevented from becoming unnecessarily long, and the MODEM is prevented from breaking down.

According to another aspect of the present invention, the communication terminal device includes a decelerating unit which decelerates a communication speed when the judging unit judges that the communication is abnormal.

When the silent state generates periodically and the communication is determined to be abnormal, the communication speed is decelerated. Thus, communication time is prevented from becoming unnecessarily long, and the MODEM is prevented from breaking down.

According to another aspect of the present invention, in a communication system, information communication is carried out between analog communication terminal devices via an IP network. The communication system includes a monitor unit, a determining unit, and a judging unit. The monitor unit monitors a silence generating interval by detecting energy of a voice receiving signal. The determining unit determines whether or not the silence generating interval monitored by the monitoring unit is periodic. The judging unit judges that the communication is abnormal when the determining unit determines that the silence generating interval is periodic.

According to such a communication system, a periodic silent state resulting from a packet loss in the IP network is detected, and the communication is judged to be abnormal. As a result, communication time is prevented from becoming unnecessarily long, and the MODEM is prevented from breaking down.

According to the present invention, energy of the voice receiving signal is detected to monitor the silence generating interval. When the silent state generates periodically, the communication is judged to be abnormal, and necessary measures are taken. As a result, communication time is prevented from becoming unnecessarily long, and the MODEM is prevented from breaking down.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 illustrates a configuration of a communication system including a facsimile machine according to the present invention.

FIG. 2 is a flowchart illustrating an operation protocol of a recipient facsimile machine when carrying out a communication with a transmitter facsimile machine according to the present invention.

FIG. 3 is a flowchart illustrating an operation protocol (a subroutine of step S5 in FIG. 2) of a process for receiving image data in a facsimile machine according to the present invention.

### DETAILED DESCRIPTION OF PREFERRED EMBODIMENTS

Embodiments of the present invention are described with reference to the drawings. The present invention is not limited to the embodiments described hereinafter.

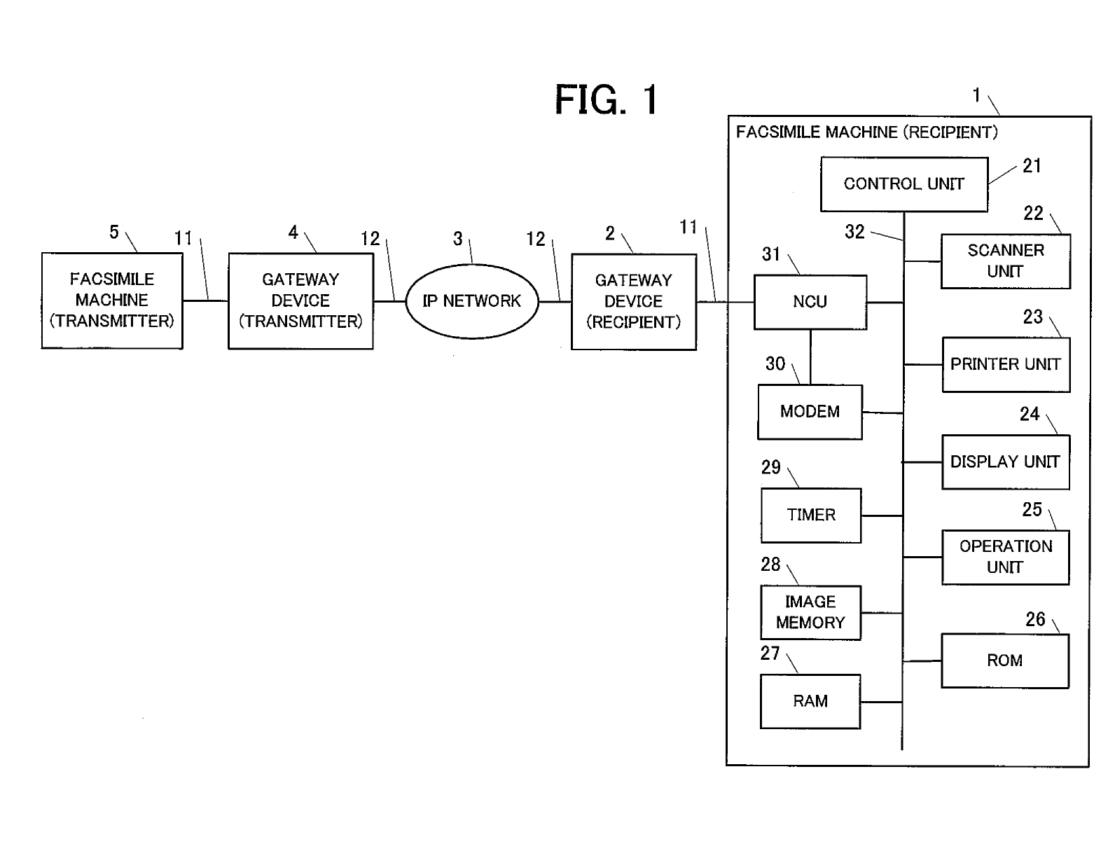

FIG. 1 illustrates a configuration of a communication system including a facsimile machine as a communication terminal device according to an embodiment of the present invention. In FIG. 1, reference numeral 1 denotes a recipient facsimile machine. A recipient gateway device 2 is connected to the facsimile machine 1 via an analog communication line 11. The gateway device 2 is connected to an IP network 3 via a relay communication line 12. A transmitter gateway device 4 is connected to the IP network 3 via the relay communication line 12. A transmitter facsimile machine 5 is connected to the gateway device 4 via the analog communication line 11. The facsimile machines 1 and 5 are analog communication terminal devices.

An analog facsimile signal is input from the transmitter facsimile machine 5 to the transmitter gateway device 4. The gateway device 4 encodes the input analog facsimile signal into a digital signal. The gateway device 4 extracts the encoded digital signal per byte at a constant time interval, and creates an IP packet from data of the extracted byte. Then, the gateway device 4 transmits the created IP packet to the IP network 3 via the relay communication line 12.

The recipient gateway device 2 receives the IP packet transmitted from the IP network 3, and extracts the data portion of the received IP packet per byte. The gateway device 2 decodes the extracted digital data portion to convert into an analog signal, and outputs the converted analog facsimile signal to the recipient facsimile machine 1 via the analog communication line 11.

As described above, a facsimile communication using the IP network 3 is carried out between the transmitter facsimile machine 5 and the recipient facsimile machine 1. In this case, in the communication system according to the present invention, a communication is carried out under a digital packet switching method between the gateway device 4 and the gateway device 2 via the relay communication line 12, the IP network 3, and the relay communication line 12. Between the facsimile machine 5 and the gateway device 4, a communication is carried out under an analog communication line switching method via the analog communication line 11. Between the gateway device 2 and the facsimile machine 1, a communication is carried out under the analog communication line switching method via the analog communication line 11.

The facsimile machine 1 includes a control unit 21, a scanner unit 22, a printer unit 23, a display unit 24, an operation unit 25, a Read Only Memory (ROM) 26, a Random Access Memory (RAM) 27, an image memory 28, a timer 29, a MODEM 30, and a Network Control Unit (NCU) 31 or the like.

The control unit 21 includes a Central Processing Unit (CPU) or the like. The control unit 21 is connected to each of the above-mentioned hardware components of the facsimile machine 1 via a bus 32, and controls each of the hardware components. The control unit 21 executes various software functions in accordance with a control program stored in the ROM 26. By executing an operation process described hereinafter, the control unit 21 functions as a monitor unit for monitoring a silence generating interval by detecting energy of a voice receiving signal, a determining unit for determining whether or not the silence generating interval is periodic a judging unit for judging that the communication is abnormal, an interrupting unit for interrupting the communication, and a decelerating unit for decelerating a communication speed.

The scanner unit 22 scans an original document by an optical system using a Charge Coupled Device (CCD) or the like, and outputs scanned image data. The printer unit 23 is an electrophotographic printer, and prints out an image onto printing paper according to image data of an original document scanned by the scanner unit 22, or image data received in a facsimile communication or the like.

The display unit 24 is a display device such as a Liquid Crystal Display (LCD) or a Cathode Ray Tube (CRT) display. The display unit 24 displays an operation status of the facsimile machine 1, and displays a screen for urging a user to perform an input operation or a screen for issuing an alarm to the user. The operation unit 25 includes a character key, a ten-key numeric pad, a speed-dial key, a one-touch dial key, and various other function keys or the like necessary for operating the facsimile machine 1. When the display unit 24 is a touch-screen display, a part or all of the various keys of the operation unit 25 may be substituted.

The ROM 26 stores various software control programs necessary for an operation of the facsimile machine 1. The RAM 27 stores temporary data that generates when a software program is executed. The image memory 28 includes a Dynamic RAM (DRAM) or the like. The image memory 28 stores image data obtained by scanning an original document, and image data received from another facsimile machine or the like. The timer 29 is used for clocking an ON period (sound period) and an OFF period (silent state) or the like described hereinafter.

The MODEM 30 is a faxmodem connected to the bus 32 and capable of carrying out a facsimile communication. The MODEM 30 is directly connected to the NCU 31 and is also connected to the bus 32. The NCU 31 is a hardware for closing and opening a connection with the analog communication line 11. The NCU 31 connects the MODEM 30 to the analog communication line 11 when necessary. The MODEM 30 includes a function for detecting energy of a voice receiving signal input via the analog communication line 11. The control unit 21 distinguishes a sound state and a silent state in accordance with a result of a detection of the voice receiving signal detected by the MODEM 30.

The facsimile machine 1 cannot carry out a communication via an IP network (IP communication) using a digital packet directly. Rather, the facsimile machine 1 is an analog communication terminal device capable of carrying out a communication via the IP network 3 (IP communication) after carrying out a digital-to-analog conversion in the gateway device 2. Accordingly, in IP communication using facsimile machine 1, a packet loss generated in the IP network 3 frequently causes silence and appears on the analog communication line 11.

According to a known technology for supplementing the packet loss, a Packet Loss Control (PLC) is carried out when the digital-to-analog conversion is carried out within the gateway device 2. This PLC technology is unnecessary for a communication terminal device capable of carrying out an IP communication using a digital packet directly. Such a communication terminal device can handle a packet loss by another method. Meanwhile, in the communication system of the present invention, since the digital-to-analog conversion is carried out by the PLC, when a packet loss generates periodically, the MODEM 30 may fall into a state incapable of carrying out any process due to a drastic fluctuation in input analog signals.

Thus, the facsimile machine 1 according to the invention monitors a silence generating interval by using an energy detecting function of the MODEM 30 for detecting a voice receiving signal. The facsimile machine 1 determines whether or not the silent state is generating periodically. When the silent state generates periodically, the facsimile machine 1 judges that the communication is abnormal and interrupts the communication or decelerates the communication speed. By carrying out such a control, it is possible to prevent the communication time from becoming unnecessarily long, or the MODEM 30 or the like from breaking down.

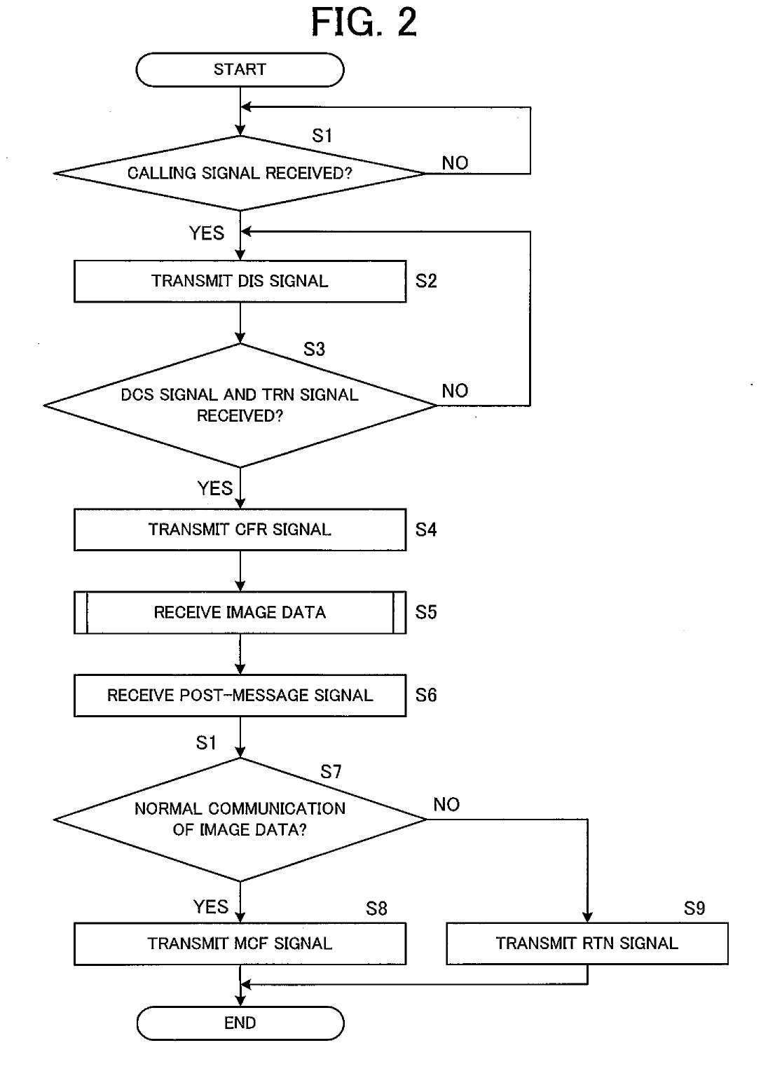

FIG. 2 is a flowchart illustrating an operation protocol of the recipient facsimile machine 1 when carrying out a communication with the transmitter facsimile machine 5 according to the invention.

The control unit 21 determines whether or not a calling signal has been received (step S1). When a calling signal has not been received (step S1: NO), the control unit 21 continues to monitor whether or not a calling signal has been received. When receiving a calling signal (step S1: YES), the control unit 21 transmits a Digital Identification Signal (DIS) signal indicating a function of the recipient facsimile machine 1 to the facsimile machine 5 (step S2). Then, the control unit 21 determines whether or not a Digital Command Signal (DCS) signal and a Training (TRN) signal have been received from the facsimile machine 5 (step S3). Further, the DCS signal is a signal in which a function has been designated by the facsimile machine 5, and the TRN signal is a signal for an adjustment between MODEMs. When the DCS signal and the TRN signal have not been received (step S3: NO), the control unit 21 retransmits a DIS signal.

When receiving the DCS signal and the TRN signal (step S3: YES), the control unit 21 transmits a Confirmation to Receive (CFR) signal to the facsimile machine 5 indicating that a reception preparation has been completed (step S4). When the facsimile machine 5 receives the CFR signal, the facsimile machine 5 transmits image data to the facsimile machine 1, and the facsimile machine 1 receives the image data (step S5).

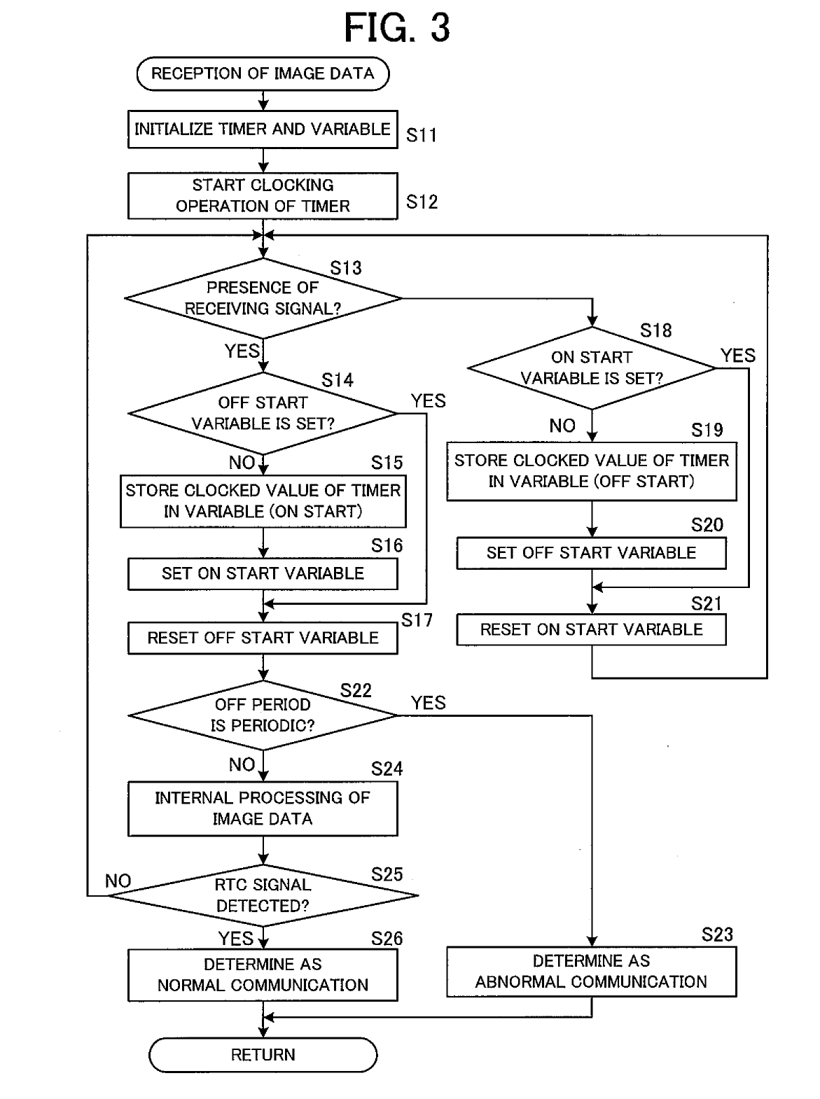

FIG. 3 is a flowchart illustrating an operation protocol (a subroutine of step S5 of FIG. 2) of a process for receiving image data in the facsimile machine 1 according to the invention.

First, the control unit 21 initializes the timer 29 and a variable in the RAM 27 (step S11). Then, the control unit 21 starts a clocking operation of the timer 29 (step S12). The control unit 21 determines whether or not there is a receiving signal, i.e., whether it is a sound state or a silent state (step S13).

In case of a presence of the receiving signal (step S13: YES), the control unit 21 determines whether or not an OFF start variable is set (step S14). When the OFF start variable is set (step S14: YES), the control unit 21 resets an OFF start variable (step S17). When the OFF start variable is not set (step S14: NO), the control unit 21 stores a clocked value of the timer 29 in the variable, and starts to clock an ON period (a period when a receiving signal exists, i.e. a period of a sound state) (step S15). The ON start variable is set (step S16), and the OFF start variable is reset (step S17). The operation proceeds onto step S22.

Meanwhile, in case of an absence of the receiving signal (step S13: NO), i.e. when the receiving signal is interrupted, the control unit 21 determines whether or not the ON start variable is set (step S18). When the ON start variable is set (step S18: YES), the control unit 21 resets the ON start variable (step S21). When the ON start variable is not set (step S18: NO), the control unit 21 stores a closed value of the timer 29 in the variable, and starts to clock an OFF period (a period when a receiving signal does not exist, i.e., a period of a silent state) (step S19). Then, the OFF start variable is set (step S20), and the ON start variable is reset (step S21). The, the operation returns to step S13.

The control unit 21 determines whether or not the detected OFF period is periodic (step S22). When the OFF period is periodic (step S22: YES), the control unit 21 determines that the communication is abnormal, and ends the reception of the image data (step S23).

Meanwhile, when the OFF period is not periodic (step S22: NO), the control unit 21 executes an internal processing, e.g. for storing received image data in the image memory 28 (step S24). Then, the control unit 21 determines whether or not a Return to Control (RTC) signal has been detected (step S25). When the RTC signal is not detected (step S25: NO), the operation returns to step S13. When the RTC signal is detected (step S25: YES), the control unit 21 determines that the communication is normal, and ends the reception of the image data (step S26).

Referring to FIG. 2 again, the facsimile machine 1 receives a post-message signal from the facsimile machine 5 (step S6). Then, the facsimile machine 1 determines whether or not a determination has been made that the communication is normal as a result of the detection operation described with reference to the flowchart of FIG. 3 (step S7). When the communication is normal (step S7: YES), the facsimile machine 1 transmits a Message Confirmation (MCF) signal to the facsimile machine 5 (step S8), and the communication ends.

Meanwhile, when the communication is abnormal (step S7: NO), the facsimile machine 1 transmits a Retain Negative (RTN) signal to the facsimile machine 5 (step S9), and ends the communication in an interrupted state. As described above, according to the invention, when an abnormality generates in the communication as a result of packet loss, the communication is interrupted so that the MODEMs of both facsimile machines 1 and 5 do not break down. The possibility of the MODEM breaking down increases if the facsimile machine 1 waits until the end after a packet loss generates. According to the present invention, when the facsimile machine 1 judges that the communication is abnormal, the facsimile machine 1 promptly quits from the communication process. As a result, the MODEM is prevented from breaking down.

A facsimile machine, which includes a faxmodem of the International Telecommunication Union (ITU) recommendation V.34 communication mode, can change the communication speed of image data by retraining the MODEM. In such a facsimile machine, when periodic OFF periods are detected and the communication is judged to be abnormal as a result of packet loss, the communication speed of the image data is decelerated to prevent the MODEM from breaking down.

While the present invention has been described with respect to embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. A communication terminal device comprising:
means for monitoring a silence generating interval by detecting energy of a voice receiving signal received via an Internet protocol network;
means for determining whether or not the silence generating interval monitored by the means for monitoring is periodic; and
means for judging that a communication is abnormal when the means for determining determines that the silence generating interval is periodic.

2. The communication terminal device according to claim 1, further comprising means for interrupting the communication when the means for judging judges that the communication is abnormal.

3. The communication terminal device according to claim 1, further comprising means for decelerating a communication speed when the means for judging judges that the communication is abnormal.

4. The communication terminal device according to claim 1, wherein the means for monitoring includes a faxmodem having a function for detecting the energy of the voice receiving signal input via an analog communication line.

5. A communication method comprising the steps of:
receiving a voice receiving signal from a communication terminal device of another end via an Internet protocol network;
monitoring a silence generating interval by detecting energy of the received voice receiving signal;
determining whether or not the monitored silence generating interval is periodic; and
judging that a communication is abnormal when the silence generating interval is determined to be periodic.

6. The communication method according to claim 5, further comprising the step of interrupting the communication when the communication is judged to be abnormal.

7. The communication method according to claim 5, further comprising the step of decelerating a communication speed when the communication is judged to be abnormal.

8. The communication method according to claim 5, wherein the monitoring step uses a faxmodem including a function for detecting the energy of the voice receiving signal input via an analog communication line.

9. A communication system comprising:
an analog transmitter communication terminal device;
a transmitter gateway device connected to the transmitter communication terminal device via an analog communication line;
a recipient gateway device connected to the transmitter communication terminal device via an Internet protocol network; and
a recipient communication terminal device connected to the recipient gateway device via the analog communication line,
wherein the recipient communication terminal device includes:
means for monitoring a silence generating interval by detecting energy of a voice receiving signal received via the analog communication line;
means for determining whether or not the silence generating interval monitored by the means for monitoring is periodic; and
means for judging that a communication is abnormal when the means for determining determines that the silence generating interval is periodic.

10. The communication system according to claim 9, wherein the recipient communication terminal device further comprises means for interrupting the communication when the communication is judged to be abnormal.

11. The communication system according to claim 9, wherein the recipient communication terminal device further comprises means for decelerating a communication speed when the communication is judged to be abnormal.

12. The communication system according to claim 9, wherein the means for monitoring includes a faxmodem including a function for detecting the energy of the voice receiving signal input via the analog communication line.

13. The communication system according to claim 9, wherein between the recipient communication terminal device and the transmitter gateway device, and between the recipient gateway device and the recipient communication terminal device, information communication is carried out under an analog communication line switching method.

14. The communication system according to claim 9, wherein between the transmitter gateway device and the recipient gateway device, information communication is carried out under a digital packet switching method.

15. A communication terminal device comprising:
a monitor unit that monitors a silence generating interval by detecting energy of a voice receiving signal received via an Internet protocol network;
a determining unit that determines whether or not the silence generating interval monitored by the monitor unit is periodic; and
a judging unit that judges that a communication is abnormal when the determining unit determines that the silence generating interval is periodic.

16. The communication terminal device according to claim 15, further comprising an interrupting unit that interrupts the communication when the judging unit judges that the communication is abnormal.

17. The communication terminal device according to claim 15, further comprising a decelerating unit that decelerates a communication speed when the judging unit judges that the communication is abnormal.

18. The communication terminal device according to claim 15, wherein the monitor unit includes a faxmodem having a function for detecting the energy of the voice receiving signal input via an analog communication line.

19. A communication system comprising the communication terminal device of claim 15 as a recipient communication terminal device, and further comprising:
an analog transmitter communication terminal device;
a transmitter gateway device connected to the transmitter communication terminal device via an analog communication line; and
a recipient gateway device connected to the transmitter communication terminal device via an Internet protocol network,
wherein the recipient communication terminal device is connected to the recipient gateway device via the analog communication line.

20. The communication system according to claim 19,
wherein between the recipient communication terminal device and the transmitter gateway device, and between the recipient gateway device and the recipient communication terminal device, information communication is carried out under an analog communication line switching method, and
wherein between the transmitter gateway device and the recipient gateway device, information communication is carried out under a digital packet switching method.
